(19) United States
(12) Patent Application Publication
(10) Pub. No.: US 2017/0051843 A1
(43) Pub. Date: Feb. 23, 2017

(54) Method for Managing Water Consumption in Commercial and Residential Buildings

(71) Applicant: MOEIN AZIZGOLSHANI, BEVERLY HILLS, CA (US)

(72) Inventor: MOEIN AZIZGOLSHANI, BEVERLY HILLS, CA (US)

(21) Appl. No.: 15/240,086

(22) Filed: Aug. 18, 2016

Related U.S. Application Data
(60) Provisional application No. 62/206,395, filed on Aug. 18, 2015.

(51) Int. Cl. F16K 35/06

(52) U.S. Cl. CPC F16K 35/06

(57) ABSTRACT

A method for managing water consumption in commercial and residential buildings allows landlords and property owners to have more control over the water usage. The position of a valve actuator is manipulated to reduce the volumetric flow rate from a water inlet through a shutoff valve to a water outlet. The reduction in volumetric flow rate results in less water flowing through the water outlet than would normally flow through the outlet without the implementation of the method. The valve actuator is secured with an actuator position retention mechanism in order to prevent access to the valve actuator by unauthorized persons.

The current application claims a priority to the U.S. Provisional Patent application Ser. No. 62/206,395 filed on Aug. 18, 2016.

### FIELD OF THE INVENTION

The present invention relates generally to a system to manage water consumption. More specifically, the present invention is a system to manage water pressure for outlets within commercial and residential buildings.

### BACKGROUND OF THE INVENTION

Water conservation is an increasingly important idea for maintaining or increasing fresh water supplies around the world. While there are many ways for water to be wasted, some prominent ways of wasting water include leaving water outlets, such as faucets, spigots and show heads, open for extended periods of time. Limiting the pressure of water through faucets, spigots and showerheads greatly reduces the amount of waste water though leaving these outlets open for extended periods of time as the volumetric flow rate of water is reduced.

The present invention is a method for managing water consumption in commercial and residential buildings. The present invention allows the user to reduce the flow of water through water outlets without cutting or removing piping. The flow of water is restricted as the shutoff valve is adjusted to reduce the cross-sectional area which the flow of water is passing through. The reduction in cross-sectional area causes a drop in fluid pressure, and therefore reduces the volumetric flow rate for the flow of water out of an outlet. The reduction in volumetric flow rate results in less water consumed. With less water consumed, the cost for water distribution to the commercial or residential building is reduced.

### BRIEF DESCRIPTION OF THE DRAWINGS

FIG. 1 is a flow diagram detailing the steps of the present invention.

FIG. 2 is a flow diagram detailing an embodiment of the present invention including a water flow meter.

FIG. 3 is a flow diagram detailing an embodiment of the present invention, wherein a proportionate reduction from the initial volumetric flow is calculated.

FIG. 4 is a flow diagram detailing an embodiment of the present invention incorporating a set of predefined output flow rates.

FIG. 5 is a flow diagram detailing an embodiment of the actuator position retention mechanism for the present invention.

FIG. 6 is a perspective view of the implementation of the present invention wherein a locking fixture secures the valve actuator to a gripping orifice.

FIG. 7 is a perspective view of the implementation of the present invention.

FIG. 8 is a perspective view of the actuator position retention mechanism being positioned around the valve actuator.

### DETAIL DESCRIPTIONS OF THE INVENTION

All illustrations of the drawings are for the purpose of describing selected versions of the present invention and are not intended to limit the scope of the present invention.

The present invention is a method for managing water consumption in commercial and residential buildings. The present invention allows landlords and property owners to have more control over the water usage for properties owned by each. The present invention allows the user to reduce the flow of water through water outlets without cutting or removing piping. By reducing the flow of water through water outlets, landlords and homeowners save the difference in cost for fresh water delivery to properties owned by landlords and homeowners, while reducing the consumption of drinkable water.

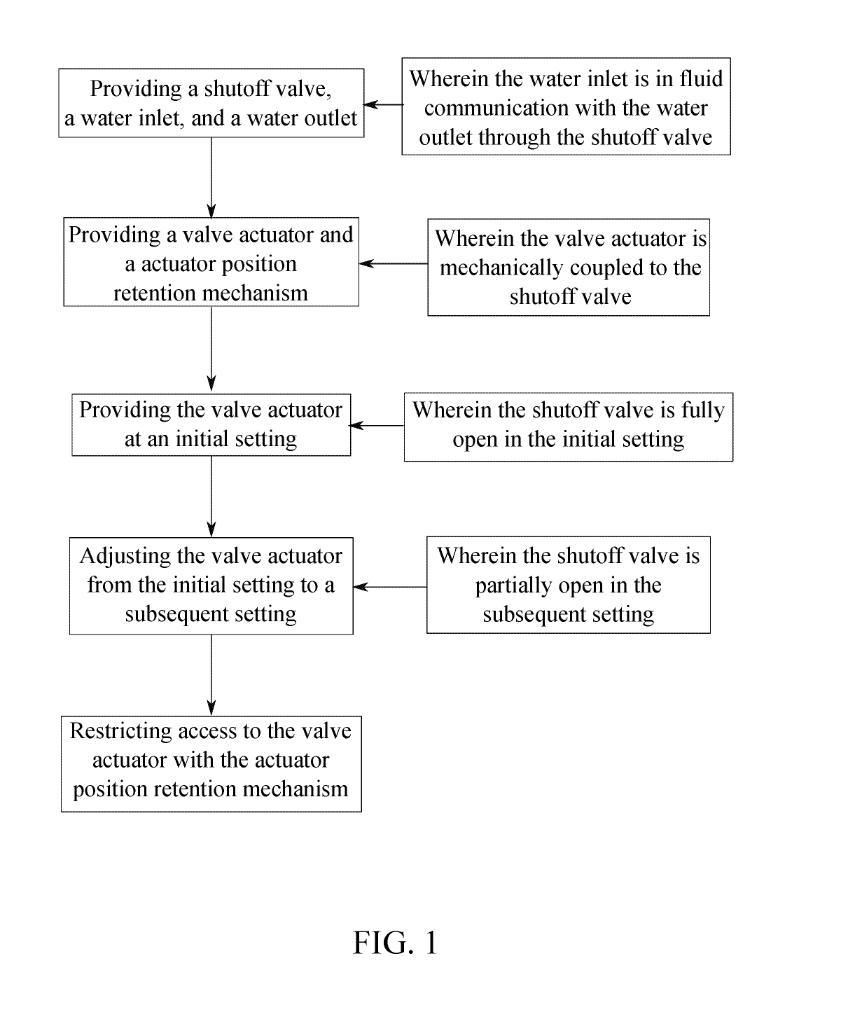

In order to implement the present invention, several necessary components are provided, including: a shutoff valve, a water inlet, and a water outlet, as detailed in FIG. 1. The water inlet is in fluid communication with the water outlet through the shutoff valve such that the shutoff valve controls the flow of water from the water inlet to the water outlet. Further necessary for the present invention, a valve actuator and an actuator position retention mechanism are included. The valve actuator is mechanically coupled to the shutoff valve in order to control the position of the shutoff valve between a fully open position to a fully closed position. The valve actuator is a handle or mechanism which opens and closes the shutoff valve. The actuator position retention mechanism prevents the valve actuator from being tampered with by unauthorized persons.

In accordance to the present invention, the valve actuator is adjusted from the initial setting to a subsequent setting, wherein the shutoff valve is at a partially open position in the subsequent setting. The subsequent setting restricts the flow of water through the shutoff valve by increasing the head loss through the shutoff valve, where head loss is loss of pressure through the shutoff valve due to friction. The loss of pressure results in a lower volumetric flow rate for water exiting a piping system through the water outlets such as a faucet, a spigot, or a shower head, where volumetric flow rate is the volume of fluid which passes through the piping system for a given time. Access to the valve actuator is then restricted with the actuator position retention mechanism, in order to prevent unauthorized persons from tampering with the position of the valve actuator.

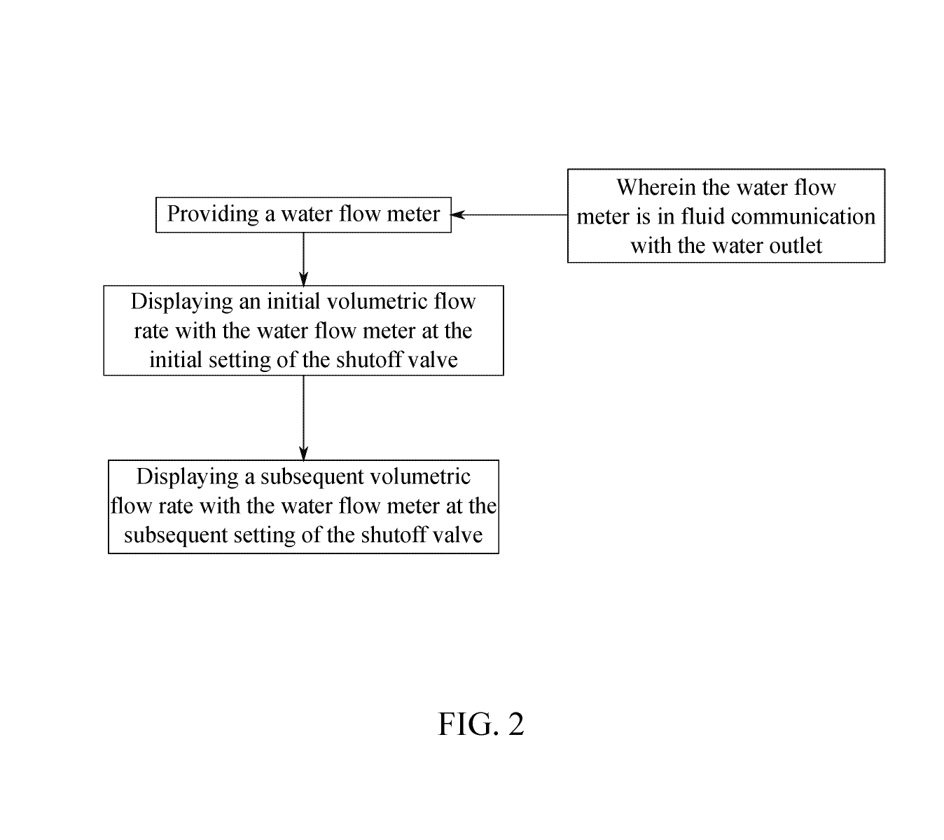

In one embodiment of the present invention, the present invention incorporates a water flow meter, as shown in FIG. 2. The water flow meter measures the volumetric flow rate for the water as the water exits the shutoff valve. The water flow meter displays an initial volumetric flow rate at the initial setting of the shutoff valve. As the valve actuator is adjusted, the water flow meter displays a subsequent volumetric flow rate at the subsequent setting of the shutoff valve. Thus, the user is able to verify a change in the volumetric flow rate due to the valve actuator adjustments.

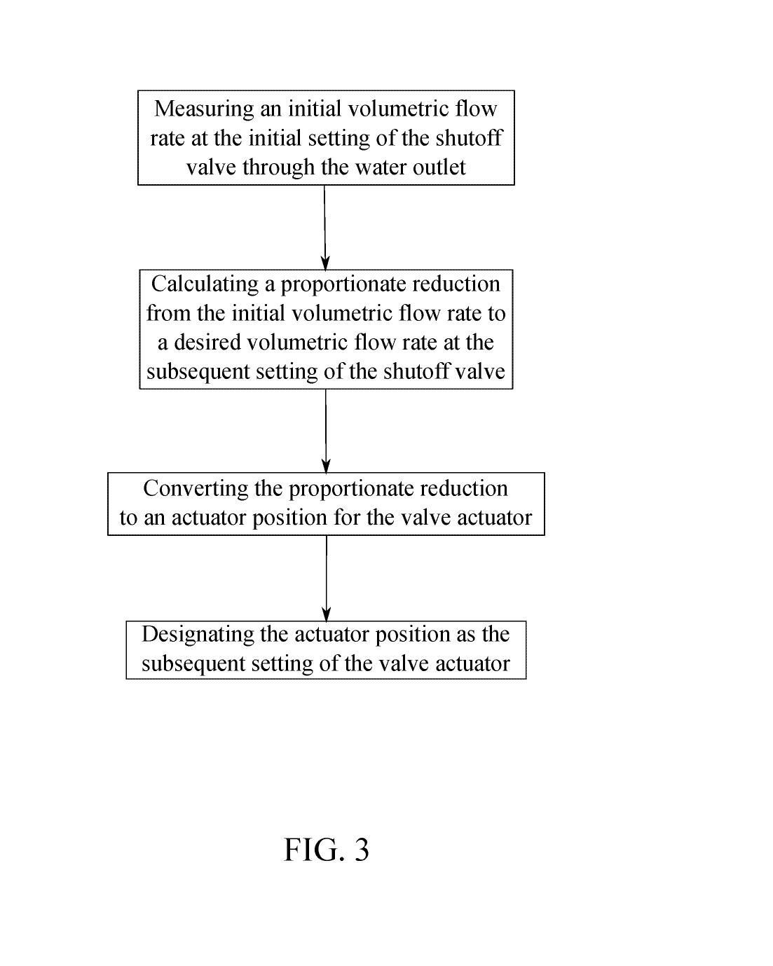

In another embodiment of the present invention, the valve actuator is able to be controlled from the initial setting to the subsequent setting for a discrete output volumetric flow, as shown in FIG. 3. The initial volumetric flow rate is measured at the initial setting of the shutoff valve through the water outlet. From the initial volumetric flow rate, a proportionate reduction is calculated to a desired volumetric flow rate at the subsequent setting of the shutoff valve. The proportionate reduction is an assessment for the change in volumetric flow rate between the initial volumetric flow rate and the desired flow rate chosen by the user. The proportionate reduction is then converted to an actuator position for the valve actuator. The actuator position is the position which the shutoff valve restricts the volumetric flow rate to the desired volumetric flow rate. The actuator position is then designated as the subsequent setting of the valve actuator such that the shutoff valve restricts the volumetric flow rate to the desired flow rate when the valve actuator is adjusted.

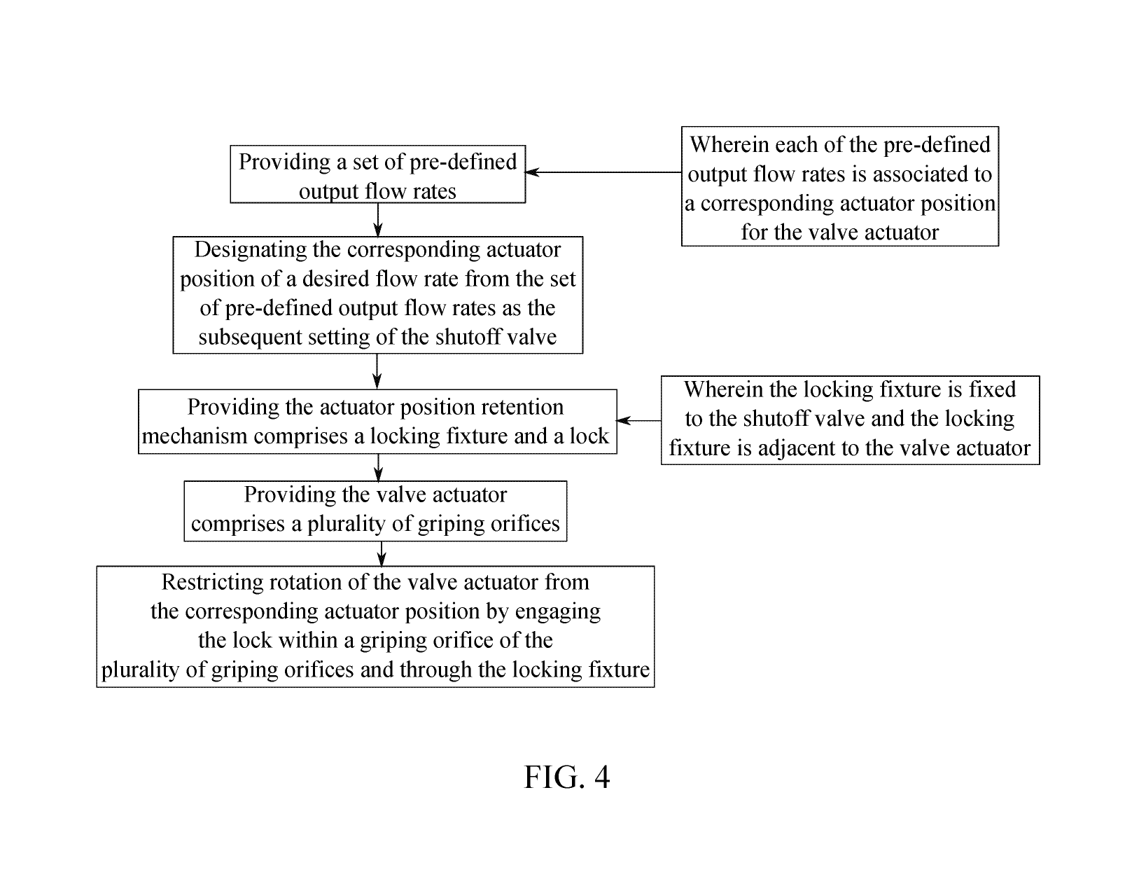

In still another embodiment of the present invention, a set of pre-defined output flow rates, such as 1, 1.25, 1.5 1.75, 2 and 2.5 ounces per second for example, are used to position the actuator at discrete positions, in accordance to FIG. 4. Each of the pre-defined output flow rates is associated to a corresponding actuator position for the valve actuator. The corresponding actuator position of a desired flow rate from the set of pre-defined output flow rates is designated as the subsequent setting for the shutoff valve. Thus, the user is able to set the volumetric flow rate exiting the shutoff valve directly as positioning the valve actuator to the corresponding actuator position results in the associated pre-defined output flow rate.

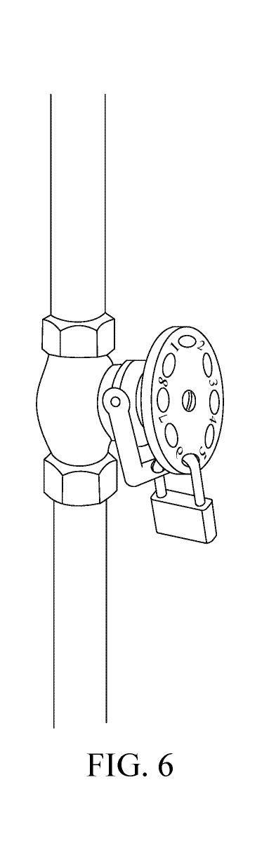

In some embodiments of the present invention, the actuator position retention mechanism comprises a locking fixture and a lock, and the valve actuator comprises a plurality of gripping orifices, as shown in FIG. 4 and FIG. 6. The lock engages the locking fixture and the plurality of gripping orifices in order to restrict rotation of the valve actuator. The locking fixture is fixed to the shutoff valve. The locking fixture is positioned adjacent to the valve actuator. The plurality of gripping orifices allows a person to easily turn the valve actuator. The rotation of the valve actuator is restricted from rotating from the corresponding actuator position by engaging the lock within a gripping orifice of the plurality of gripping orifices and through the locking fixture. This configuration prevents the rotation of the actuator valve by obstructing the rotation of the valve actuator with the locking fixture. The locking fixture is able to be fixed within the gripping orifice in order to prevent unauthorized persons from manipulating the valve actuator.

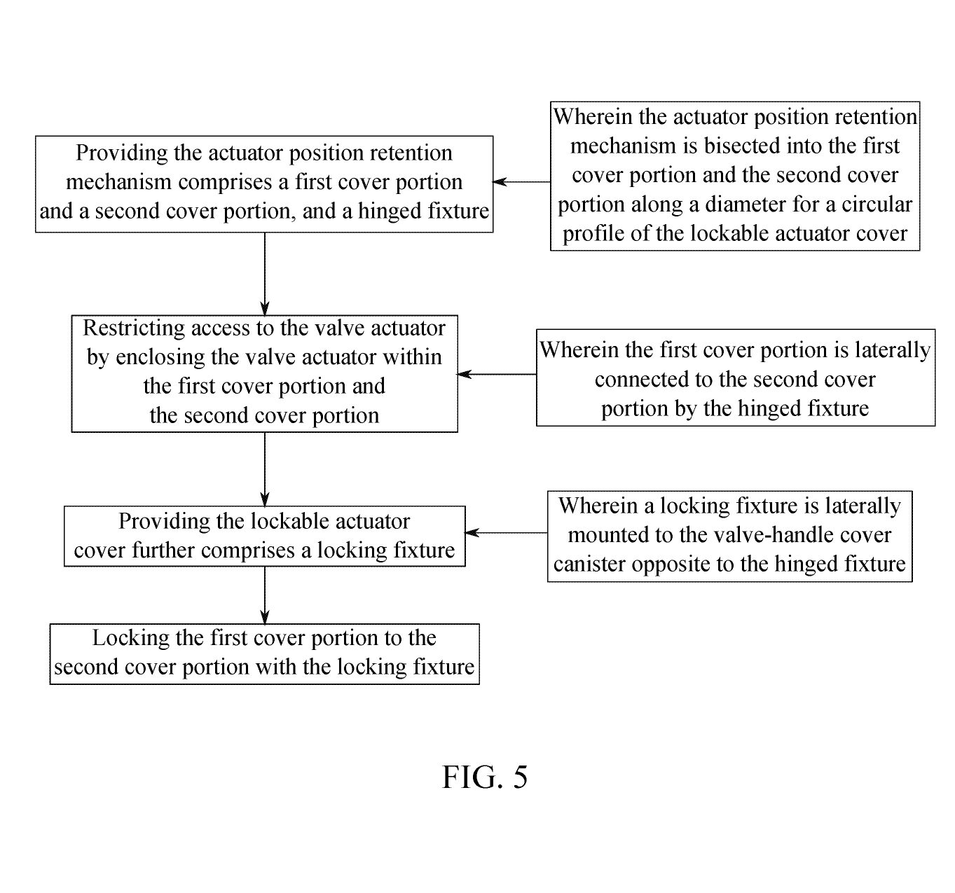

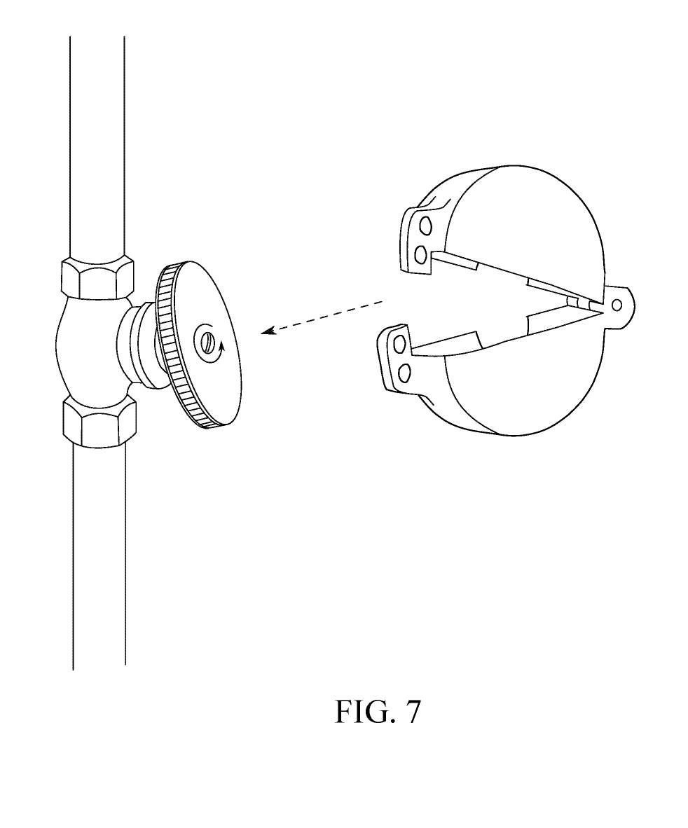

In accordance to the preferred embodiment of the present invention, the actuator position retention mechanism comprises a first cover portion and a second cover portion and a hinged fixture, as detailed in FIG. 5. The first cover portion and the second cover portion enclose the valve actuator to prevent tampering with the valve actuator in order to maintain a consistent volumetric flow rate out of the shutoff valve. The hinged fixture allows the separation of the first cover portion from the second cover portion while retaining the connection between the first cover portion and the second cover portion. The actuator position retention mechanism is bisected into the first cover portion and the second cover portion along a diameter for a circular profile of the actuator position retention mechanism. The first cover portion is laterally connected to the second cover portion by the hinged fixture to allow the first cover portion and the second cover portion to open and close around the valve actuator, as detailed in FIG. 7. Access to the valve actuator is restricted by enclosing the valve actuator within the first cover portion and the second cover portion.

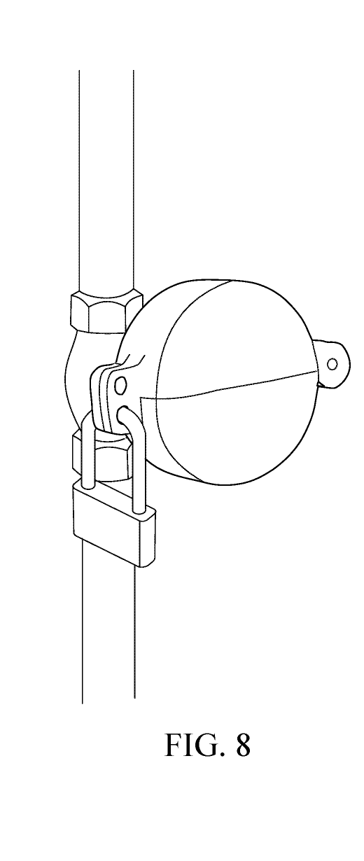

The actuator position retention mechanism, in some embodiments, further comprises a locking fixture. The locking fixture allows the actuator position retention mechanism to secure the actuator position retention mechanism about the valve actuator in order to prevent unauthorized persons from tampering with the valve actuator, as shown in FIG. 8. The first cover portion is locked to the second cover portion with the locking fixture, in order to prevent access to the valve actuator.

In accordance to Table 1, the volumetric flow rate is able to be verified to the user desired flow rate by measuring the output flow rate from a faucet, spigot, or show head. For example, when implementing the present invention to a faucet, the user opens the faucet when the shutoff valve is the subsequent setting. Using a container of known volume, the user measures the time it takes to fill the container. By dividing the volume by the time, the user is able to derive the volumetric flow rate through the faucet.

TABLE 1

| Time to Fill 20 | | |
|---|---|---|
| Ounce Container | Ounce Per | Gallon Per |
| (Seconds) | Second | Minute |
| 4 | 5.00 | 2.34 |
| 6 | 3.33 | 1.56 |
| 8 | 2.50 | 1.17 |
| 8 | 2.50 | 1.17 |
| 10 | 2.00 | 0.94 |
| 12 | 1.67 | 0.78 |
| 14 | 1.43 | 0.67 |
| 16 | 1.25 | 0.59 |
| 18 | 1.11 | 0.52 |
| 20 | 1.00 | 0.47 |
| 22 | 0.91 | 0.43 |
| 24 | 0.83 | 0.39 |
| 26 | 0.77 | 0.36 |
| 28 | 0.71 | 0.33 |
| 30 | 0.67 | 0.31 |

As seen in Table 1, the present invention is able to reduce the volumetric flow rate from an initial volumetric flow rate of 5 ounces per second (oz./s) to a lower desired output flow rate. The lower desired output is preferred to be between 1 oz./s and 2.5 oz./s such that the volumetric flow rate provides a sufficient water stream out from an outlet. The lower desired output is able to be adjusted to 0.67 oz./s for extreme water saving situations.

Although the invention has been explained in relation to its preferred embodiment, it is to be understood that many other possible modifications and variations can be made without departing from the spirit and scope of the invention as hereinafter claimed.

What is claimed is:

1. A method for managing water consumption in commercial and residential buildings comprises the steps of:
providing a shutoff valve, a water inlet, and a water outlet, wherein the water inlet is in fluid communication with the water outlet through the shutoff valve;
providing a valve actuator and an actuator position retention mechanism, wherein the valve actuator is mechanically coupled to the shutoff valve;
providing the valve actuator at an initial setting, wherein the shutoff valve is fully open in the initial setting;
adjusting the valve actuator from the initial setting to a subsequent setting, wherein the shutoff valve is partially open in the subsequent setting; and
restricting access to the valve actuator with the actuator position retention mechanism.

2. The method for managing water consumption in commercial and residential buildings, as claimed in claim 1, comprises the steps of:
providing a water flow meter, wherein the water flow meter is in fluid communication with the water outlet;
displaying an initial volumetric flow rate with the water flow meter at the initial setting of the shutoff valve; and
displaying a subsequent volumetric flow rate with the water flow meter at the subsequent setting of the shutoff valve.

3. The method for managing water consumption in commercial and residential buildings, as claimed in claim 1, comprises the steps of:
measuring an initial volumetric flow rate at the initial setting of the shutoff valve through the water outlet;
calculating a proportionate reduction from the initial volumetric flow rate to a desired volumetric flow rate at the subsequent setting of the shutoff valve;
converting the proportionate reduction to an actuator position for the valve actuator; and
designating the actuator position as the subsequent setting of the valve actuator.

4. The method for managing water consumption in commercial and residential buildings, as claimed in claim 1, comprises the steps of:
providing a set of pre-defined output flow rates, wherein each of the pre-defined output flow rates is associated to a corresponding actuator position for the valve actuator; and
designating the corresponding actuator position of a desired flow rate from the set of pre-defined output flow rates as the subsequent setting of the shutoff valve.

5. The method for managing water consumption in commercial and residential buildings, as claimed in claim 4, comprises the steps of:
providing the actuator position retention mechanism comprises a locking fixture and a lock, wherein the locking fixture is fixed to the shutoff valve and the locking fixture is adjacent to the valve actuator; and
providing the valve actuator comprises a plurality of griping orifices;
restricting rotation of the valve actuator from the corresponding actuator position by engaging the lock within a griping orifice of the plurality of griping orifices and through the locking fixture.

6. The method for managing water consumption in commercial and residential buildings, as claimed in claim 1, comprises the steps of:
providing the actuator position retention mechanism comprises a first cover portion and a second cover portion, and a hinged fixture, wherein the actuator position retention mechanism is bisected into the first cover portion and the second cover portion along a diameter for a circular profile of the actuator position retention mechanism and the first cover portion is laterally connected to the second cover portion by the hinged fixture; and
restricting access to the valve actuator by enclosing the valve actuator within the first cover portion and the second cover portion.

7. The method for managing water consumption in commercial and residential buildings, as claimed in claim 6, comprises the steps of:
providing the actuator position retention mechanism further comprises a locking fixture, wherein a locking fixture is laterally mounted to the valve-handle cover canister opposite to the hinged fixture; and
locking the first cover portion to the second cover portion with the locking fixture.

8. A method for managing water consumption in commercial and residential buildings comprises the steps of:
providing a shutoff valve, a water inlet, and a water outlet, wherein the water inlet is in fluid communication with the water outlet through the shutoff valve;
providing a valve actuator and an actuator position retention mechanism, wherein the valve actuator is mechanically coupled to the shutoff valve;
providing the valve actuator at an initial setting, wherein the shutoff valve is fully open in the initial setting;
providing a water flow meter, wherein the water flow meter is in fluid communication with the water outlet;
displaying an initial volumetric flow rate with the water flow meter at the initial setting of the shutoff valve;
adjusting the valve actuator from the initial setting to a subsequent setting, wherein the shutoff valve is partially open in the subsequent setting;
restricting access to the valve actuator by enclosing the valve actuator within the actuator position retention mechanism; and
displaying a subsequent volumetric flow rate with the water flow meter at the subsequent setting of the shutoff valve.

9. The method for managing water consumption in commercial and residential buildings, as claimed in claim 8, comprises the steps of:
measuring an initial volumetric flow rate at the initial setting of the shutoff valve through the water outlet;
calculating a proportionate reduction from the initial volumetric flow rate to a desired volumetric flow rate at the subsequent setting of the shutoff valve;
converting the proportionate reduction to an actuator position for the valve actuator; and
designating the actuator position as the subsequent setting of the valve actuator.

10. The method for managing water consumption in commercial and residential buildings, as claimed in claim 8, comprises the steps of:
providing a set of pre-defined output flow rates, wherein each of the pre-defined output flow rates is associated to a corresponding actuator position for the valve actuator; and
designating the corresponding actuator position of a desired flow rate from the set of pre-defined output flow rates as the subsequent setting of the shutoff valve.

11. The method for managing water consumption in commercial and residential buildings, as claimed in claim 10, comprises the steps of:
providing the actuator position retention mechanism comprises a locking fixture and a lock, wherein the locking fixture is fixed to the shutoff valve and the locking fixture is adjacent to the valve actuator; and
providing the valve actuator comprises a plurality of griping orifices;
restricting rotation of the valve actuator from the corresponding actuator position by engaging the lock within a griping orifice of the plurality of griping orifices and through the locking fixture.

12. The method for managing water consumption in commercial and residential buildings, as claimed in claim 8, comprises the steps of:
providing the actuator position retention mechanism comprises a first cover portion and a second cover portion, and a hinged fixture, wherein the actuator position retention mechanism is bisected into the first cover portion and the second cover portion along a diameter for a circular profile of the actuator position retention mechanism and the first cover portion is laterally connected to the second cover portion by the hinged fixture; and
restricting access to the valve actuator by enclosing the valve actuator within the first cover portion and the second cover portion.

13. The method for managing water consumption in commercial and residential buildings, as claimed in claim 12, comprises the steps of:
providing the actuator position retention mechanism further comprises a locking fixture, wherein a locking fixture is laterally mounted to the valve-handle cover canister opposite to the hinged fixture; and
locking the first cover portion to the second cover portion with the locking fixture.
